(19) United States
(12) Patent Application Publication
(10) Pub. No.: US 2021/0232759 A1
(43) Pub. Date: Jul. 29, 2021

(54) SYSTEMS AND METHODS FOR PROVIDING A DATA STRUCTURE REPRESENTING PATENT CLAIMS

(71) Applicant: Specifio, Inc., MARINA DEL REY, CA (US)

(72) Inventors: Ian C. Schick, Ojai, CA (US); Kevin Knight, Marina del Rey, CA (US); Jay Priyadarshi, Seattle, WA (US); Xing Shi, Bejing (CN)

(21) Appl. No.: 17/230,548

(22) Filed: Apr. 14, 2021

Related U.S. Application Data
(63) Continuation-in-part of application No. 16/840,236, filed on Apr. 3, 2020, now Pat. No. 11,023,662.
Application No. 16/840,236 is a continuation of application No. 16/221,070, filed on Dec. 14, 2018, now abandoned.
Application No. 16/221,070 is a continuation-in-part of application No. 15/892,679, filed on Feb. 9, 2018, now Pat. No. 10,417,341.
(60) Provisional application No. 62/599,588, filed on Dec. 15, 2017.
(60) Provisional application No. 62/626,222, filed on Feb. 5, 2018.
(60) Provisional application No. 62/459,357, filed on Feb. 15, 2017.
(60) Provisional application No. 62/459,199, filed on Feb. 15, 2017.
(60) Provisional application No. 62/459,208, filed on Feb. 15, 2017.
(60) Provisional application No. 62/459,246, filed on Feb. 15, 2017.
(60) Provisional application No. 62/459,235, filed on Feb. 15, 2017.
(60) Provisional application No. 62/705,315, filed on Jun. 22, 2020.
(60) Provisional application No. 62/705,316, filed on Jun. 22, 2020.
(60) Provisional application No. 62/705,317, filed on Jun. 22, 2020.

(51) Int. Cl. G06F 40/166; G06F 16/35; G06F 40/289; G06F 16/38

(52) U.S. Cl. CPC G06F 40/166; G06F 16/38; G06F 40/289; G06F 16/35

(57) ABSTRACT

Systems and methods for providing a data structure representing patent claims are disclosed. Exemplary implementations may: obtain a claim set; process a claim line of the claim set; identify one or more features in the claim fine to be stored in the data structure; and store the one or more features in the data structure.

### CROSS REFERENCE TO RELATED APPLICATIONS

This application is a Continuation-In-Part of U.S. Non-Provisional application Ser. No. 16/640,236, filed Apr. 3, 2020 and entitled “SYSTEMS AND METHODS FOR PROVIDING ADAPTIVE SURFACE TEXTURE IN AUTO-DRAFTED PATENT DOCUMENTS”; and also claims the benefit of U.S. Provisional Application No. 62/705,316 filed Jun. 22, 2020 and entitled “SYSTEMS AND METHODS FOR DETERMINING POTENTIAL SUBJECT MATTER CONFLICTS AMONG PATENT MATTERS”; U.S. Provisional Application No. 62/705,317, filed Jun. 22, 2020 and entitled “SYSTEMS AND METHODS FOR IDENTIFYING AND/OR EXPANDING CLAIM SUPPORT IN A PATENT APPLICATION SPECIFICATION”; and U.S. Provisional 62/705,315, filed Jun. 22, 2020 and entitled “SYSTEMS AND METHODS FOR DETERMINING WHETHER MULTIPLE INVENTIONS ARE CLAIMED IN A SINGLE PATENT APPLICATION”, all of which are hereby incorporated by reference in their entireties.

### FIELD OF THE DISCLOSURE

The present disclosure relates to systems and methods for providing a data structure representing patent claims.

### BACKGROUND

Patent applications are documents prepared by licensed patent practitioners. These professionals are either patent attorneys (scientists/engineers with a law degree) or patent agents (scientists/engineers without a law degree). Once prepared, a patent application is filed with the United States Patent & Trademark Office (USPTO) where it is examined by a Patent Examiner. Each application is ultimately rejected or allowed to issue as a U.S. Patent.

A patent application has three main parts: claims, specification, and figures. The claims are a numbered list of sentences that precisely define what s being asserted as the invention. In other words, the claims attempt to define the boundary between what is regarded as prior art and what is considered as inventive (i.e., useful, new, and non-obvious). The specification is the longest section. It explains how to make and use the claimed invention. Finally, the figures complement the specification and depict the claimed features.

The profitability of patent preparation for law firms has been in decline due to a number of factors. More than ever, it is market forces rather than practitioner experience and competence that tend to drive fee amounts for preparing patent applications. The collision of these market-rate fee amounts with escalating hourly rates for practitioners creates a climate where often only entry-level and non-attorney practitioners can yield profitability. In some major general practice law firms, patent preparation is even viewed as a loss-leader practice to gain a position for licensing and litigation work. Complicating things further, a talent shortage is emerging with client demand for patent drafting eve creasing while the number of new patent practitioners minted each year trending downward.

### SUMMARY

Exemplary implementations augment law firm leverage with cutting-edge machine learning and natural language generation technologies. Some implementations facilitate automated generation of complete patent application drafts based on concise practitioner inputs such as claim sets and/or drawing figures. Practitioners can now maximize their time and expertise by focusing on the client experience and only key aspects of the patent preparation process. Exemplary implementations handle the rest with near-instantaneous turnaround. For example, except for the background section and this paragraph, the present disclosure was automatically generated without human intervention based only on a single method claim set prepared by a patent practitioner.

One aspect of the present disclosure relates to a system configured for providing a data structure representing patent claims. The system may include one or more hardware processors configured by machine-readable instructions. The processor(s) may be configured to obtain a claim set. The claim set may include a numbered list of sentences that precisely define an invention. The claim set may include an independent claim and one or more dependent claims. Each dependent claim in the claim set may depend on the independent claim by referring to the independent claim or an intervening dependent claim. The processor(s) may be configured to process a claim line of the claim set. The claim line may be a unit of text having an end indicated by a presence of one or more end-of-claim line characters. The processor(s) may be configured to identify one or more features in the claim line to be stored in the data structure. The one or more features may include one or both of a main feature or a sub feature. The processor(s) may be configured to store the one or more features in the data structure. The main feature may include a step of a claimed process, a physical part of a claimed machine or article of manufacture, or a component of a claimed composition of matter. The sub feature may describe or expands on an aspect of a main feature.

Another aspect of the present disclosure relates to a method for providing a data structure representing patent claims. The method may include obtaining a claim set. The claim set may include a numbered list of sentences that precisely define an invention. The claim set may include an independent claim and one or more dependent claims. Each dependent claim in the claim set may depend on the independent claim by referring to the independent claim or an intervening dependent claim. The method may include processing a claim line of the claim set. The claim line may be a unit of text having an end indicated by a presence of one or more end-of-claim line characters. The method may include identifying one or more features in the claim line to be stored in the data structure. The one or more features may include one or both of a main feature or a sub feature. The method may include storing the one or more features in the data structure. The main feature may include a step of a claimed process, a physical part of a claimed machine or article of manufacture, or a component of a claimed composition of matter. The sub feature may describe or expands on an aspect of a main feature.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context dearly dictates otherwise.

### BRIEF DESCRIPTION OF THE DRAWINGS

FIG. 1 illustrates a system configured for providing a data structure representing patent claims, in accordance with one or more implementations.

FIG. 2 illustrates a method for providing a data structure representing patent claims, in accordance with one or more implementations.

### DETAILED DESCRIPTION

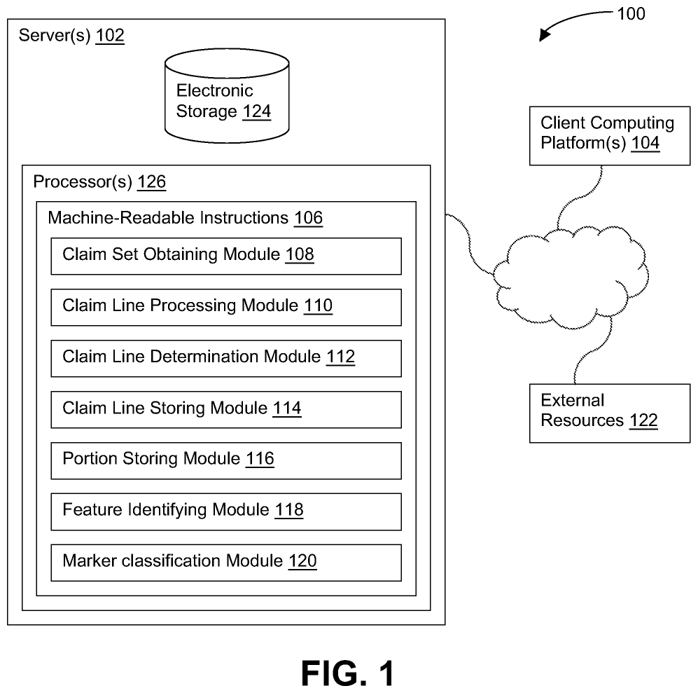

FIG. 1 illustrates a system 100 configured for providing a data structure representing patent claims, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106, Machine-readable instructions 106 may include one or more instruction modules. The instruction modules may include computer program modules. The instruction modules may include one or more of a claim set obtaining module 108, a claim line processing module 110, a claim line determination module 112, a claim line storing module 114, a portion storing module 116, a feature identifying module 118, a marker classification module 120, and/or other instruction modules.

Claim set obtaining module 108 may be configured to obtain a claim set. The claim set may include a numbered list of sentences that precisely define an invention. The claim number indicated a position of a corresponding claim in the numbered list of sentences of the claim set. The claim set may include an independent claim and one or more dependent claims. Each dependent claim in the claim set may depend on the independent claim by referring to the independent claim or an intervening dependent claim.

Claim line processing module 110 may be configured to process a claim line of the claim set. Determining whether the claim line may belong to an independent claim or a dependent claim includes determining whether the claim line includes a reference to another claim. The reference may indicate that the claim line belongs to a dependent claim. The claim line may be a unit of text having an end indicated by a presence of one or more end-of-claim line characters. By way of non-limiting example, the one or more end-of-claim line characters may include one or more of a colon, a semi-colon, or a carriage return.

Claim line determination module 112 may be configured to determine whether the claim line is a first claim line of a claim. Determining whether the claim line may be the first claim line of a claim includes determining whether the claim line begins with a claim number.

Claim line determination module 112 may be configured to, responsive to a determination that the claim line is the first claim line of a claim, determine whether the claim line belongs to an independent claim or a dependent claim.

Claim line determination module 112 may be configured to determine whether there are more claim lines in the claim set to be iterated on.

Claim line storing module 114 may be configured to, responsive to a determination that the claim line belongs to an independent claim, store the claim line as an independent claim preamble in a data structure. The independent claim preamble may convey a general description of the invention as a whole. By way of non-limiting example, the data structure may include a specialized format for organizing and storing data, the data structure including one or more of an array, a list, two or more linked lists, a stack, a queue, a graph, a table, or a tree.

The data structure may include language units from the claim set. The language units may be in patentese. Patentese may include text structure and legal jargon commonly used in patent claims. The language units may be organized in the data structure according to one or more classifications of individual language elements. By way of non-limiting example, a language element may include one or more of a word, a phrase, a clause, or a sentence. A claim may be a single sentence. By way of non-limiting example, a sentence may include a set of words that is complete and contains a subject and predicate, a sentence including a main clause and optionally one or more subordinate clauses. By way of non-limiting example, a clause may include a unit of grammatical organization next below a sentence, a clause including a subject and predicate. A phrase may include a small group of words standing together as a conceptual unit, a phrase forming a component of a clause. By way of non-limiting example, a word may include a single distinct meaningful element of language used with others to form a sentence, a word being shown with a space on either side when written or printed. By way of non-limiting example, the one or more classifications may include one or more of independent claim, dependent claim, preamble, main feature, sub feature, claim line, clause, phrase, or word.

Portion storing module 116 may be configured to, responsive to a determination that the claim line belongs to a dependent claim, store a portion of the claim line as a dependent claim preamble in the data structure. The dependent claim preamble may include a reference to a preceding claim. Identify one or more clauses in the claim line. Identifying the one or more clauses in the claim line may include applying a machine learning model to the claim line. By way of non-limiting example, the machine learning model may be based on one or more of a supervised learning algorithm, an unsupervised learning algorithm, semi-supervised learning algorithm, a regression algorithm, an instance-based algorithm, a regularized algorithm, a decision tree algorithm, a Bayesian algorithm, a clustering algorithm, an association rule learning algorithm, an artificial neural network algorithm, a deep learning algorithm, a dimensionality reduction algorithm, or an ensemble algorithm. Applying the machine learning model to the claim line may result in one or more aspects of a given clause being labeled. By way of non-limiting example, identifying the one or more clauses in the claim line may include determining whether the claim line includes one or more markers, a given marker being a trigger word, a trigger phrase, or a trigger punctuation.

Feature identifying module 118 may be configured to identify one or more features in the claim line to be stored in the data structure. The one or more features may include one or both of a main feature or a sub feature. By way of non-limiting example, the main feature may include a step of a claimed process, a physical part of a claimed machine or article of manufacture, or a component of a claimed composition of matter. The sub feature may describe or expands on an aspect of a main feature.

Marker classification module 120 may be configured to, responsive to a determination that the claim line includes one or more markers, classify individual ones of the one or more markers. In some implementations, by way of non-limiting example, classifying the given marker may include determining whether the given marker exists within a clause, whether the given marker indicates a boundary between two clauses, or whether the given marker indicates a clause containing a list.

In some implementations, server(s) 102, client computing platform(s) 104, and/or external resources 122 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 122 may be operatively linked via some other communication media.

A given client computing platform 104 may include one or more processors configured to execute computer program modules. The computer program modules may be configured to enable an expert or user associated with the given client computing platform 104 to interface with system 100 and/or external resources 122, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 122 may include sources of information outside of system 100, external entities participating with system 100, and/or other resources. In some implementations, some or all of the functionality attributed herein to external resources 122 may be provided by resources included in system 100.

Server(s) 102 may include electronic storage 124, one or more processors 126, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 124 may comprise non-transitory storage media that electronically stores information. The electronic storage media of electronic storage 124 may include one or both of system storage that is provided integrally (i.e., substantially non-removable) with server(s 102 and/or removable storage that is removably connectable to server(s) 102 via,for example, a port (e.g., a USB port, a firewire port, etc.) or a drive (e.g., a disk drive, etc.). Electronic storage 124 may include one or more of optically readable storage media (e.g., optical disks, etc,), magnetically readable storage media (e.g., magnetic tape, magnetic hard drive, floppy drive, etc.), electrical charge-based storage media (e.g., EEPROM, RAM, etc.), solid-state storage media g., flash drive, etc.), and/or other electronically readable storage media. Electronic storage 124 may include one or more virtual storage resources (e.g., cloud storage, a virtual private network, and/or other virtual storage resources). Electronic storage 124 may store software algorithms, information determined by processor(s) 126, information received from server(s) 102, information received from client computing platforms) 104, and/or other information that enables server(s) 102 to function as described herein.

Processor(s) 126 may be configured to provide information processing capabilities in server(s) 102. As such, processor (s 126 may include one or more of a digital processor, an analog processor, a digital circuit designed to process information, an analog circuit designed to process information, a state machine, and/or other mechanisms for electronically processing information. Although processor(s) 126 is shown in FIG. 1 as a single entity, this is for illustrative purposes only. In some implementations, processor(s) 126 may include a plurality of processing units. These processing units may be physically located within the same device, or processor(s) 126 may represent processing functionality of a plurality of devices operating in coordination. Processor(s) 126 may be configured to execute modules 108, 110, 112, 114, 116, 118, 120, and/or other modules. Processor(s) 126 may be configured to execute modules 108, 110, 112, 114, 116, 118, 120, and/or other modules by software; hardware; firmware; some combination of software, hardware, and/or firmware; and/or other mechanisms for configuring processing capabilities on processor(s) 126. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, and 120 are illustrated in FIG. 1 as being implemented within a single processing unit, in implementations in which processor(s) 126 includes multiple processing units, one or more of modules 108, 110, 112, 114, 116, 118, and/or 120 may be implemented remotely from the other modules. The description of the functionality provided by the different modules 108, 110, 112, 114, 116, 118, and/or 120 described below is for illustrative purposes, and is not intended to be limiting, as any of modules 108, 110, 112, 114, 116, 118, and/or 120 may provide more or less functionality than is described. For example, one or more of modules 108, 110, 112, 114, 116, 118, and/or 120 may be eliminated, and some or all of its functionality may be provided by other ones of modules 108, 110, 112, 114, 116, 118, and/or 120. As another example, processor(s) 126 may be configured to execute one or more additional modules that may perform some or all of the functionality attributed below to one of modules 108, 110, 112, 114, 116, 118, and/or 120.

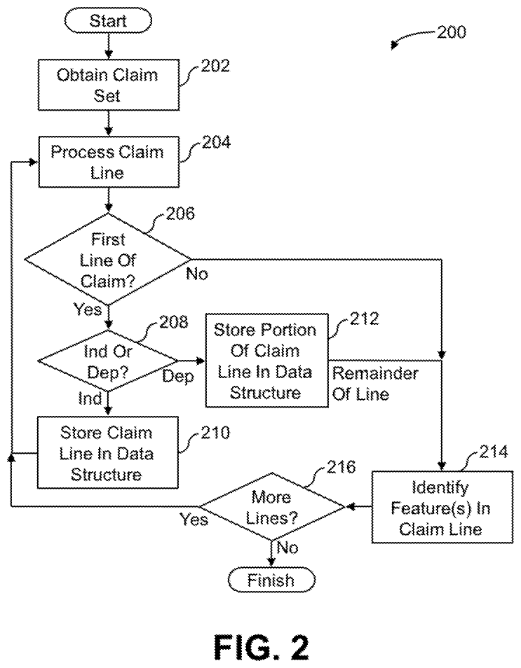

FIG. 2 illustrates a method 200 for providing a data structure representing patent claims, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include obtaining a claim set. The claim set may include a numbered list of sentences that precisely define an invention. The claim set may include an independent claim and one or more dependent claims. Each dependent claim in the claim set may depend on the independent claim by referring to the independent claim or an intervening dependent claim. Operation 202 may be performed by one or more hardware processors configured by machine-readable instructions including a module that is the same as or similar to claim set obtaining module 108, in accordance with one or more implementations.

An operation 204 may include processing a claim line of the claim set. The claim line may be a unit of text having an end indicated by a presence of one or more end-of-claim line characters. Operation 204 may be performed by one or more hardware processors configured by machine-readable instructions including a module that is the same as or similar to claim line processing module 110, in accordance with one or more implementations.

An operation 206 may include determining whether the claim line is a first claim line of a claim. Operation 206 may be performed by one or more hardware processors configured by machine-readable instructions including a module that is the same as or similar to claim line determination module 112, in accordance with one or more implementations.

An operation 208 may include, responsive to a determination that the claim line is the first claim line of a claim, determining whether the claim line belongs to an independent claim or a dependent claim. Operation 208 may be performed by one or more hardware processors configured by machine-readable instructions including a module that is the same as or similar to claim line determination module 112, in accordance with one or more implementations.

An operation 210 may include, responsive to a determination that the claim line belongs to an independent claim, storing the claim line as an independent claim preamble in a data structure. Operation 210 may be performed by one or more hardware processors configured by machine-readable instructions including a module that is the same as or similar to claim line storing module 114, in accordance with one or more implementations.

An operation 212 may include, responsive to a determination that the claim line belongs to a dependent claim, storing a portion of the claim line as a dependent claim preamble in the data structure. Identify one or more clauses in the claim line. Operation 212 may be performed by one or more hardware processors configured by machine-readable instructions including a module that is the same as or similar to portion storing module 116, in accordance with one or more implementations.

An operation 214 may include identifying one or more features in the claim line to be stored in the data structure. The one or more features may include one or both of a main feature or a sub feature. Operation 214 may be performed by one or more hardware processors configured by machine-readable instructions including a module that is the same as or similar to feature identifying module 118, in accordance with one or more implementations.

An operation 216 may include determining whether there are more claim lines in the claim set to be iterated on. Operation 216 may be performed by one or more hardware processors configured by machine-readable instructions including a module that is the same as or similar to claim line determination module 112, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for providing a data structure representing patent claims, the system comprising:
one or more hardware processors configured by machine-readable instructions to:
obtain a claim set, the claim set including a numbered list of sentences that precisely define an invention, the claim set including an independent claim and one or more dependent claims, each dependent claim in the claim set depending on the independent claim by referring to the independent claim or an intervening dependent claim;
process a claim line of the claim set, the claim line being a unit of text having an end indicated by a presence of one or more end-of-claim line characters;
identify one or more features in the claim line to be stored in the data structure, the one or more features including one or both of a main feature or a sub feature; and
store the one or more features in the data structure;
wherein the main feature includes a step of a claimed process, a physical part of a claimed machine or article of manufacture, or a component of a claimed composition of matter; and
wherein the sub feature describes or expands on an aspect of a main feature.

2. The system of claim 1, wherein the data structure includes a specialized format for organizing and storing data, the data structure including one or more of an array, a list, two or more linked lists, a stack, a queue, a graph, a table, or a tree.

3. The system of claim 1, wherein the data structure includes language units from the claim set.

4. The system of claim 3, wherein the language units are organized in the data structure according to one or more classifications of individual language elements.

5. The system of claim 4, wherein a language element includes one or more of a word, a phrase, a clause, or a sentence.

6. The system of claim 4, wherein the one or more classifications include one or more of independent claim, dependent claim, preamble, main feature, sub feature, claim line, clause, phrase, or word.

7. The system of claim 1, wherein the one or more hardware processors are further configured by machine-readable instructions to identify one or more clauses in the claim line.

8. The system of claim 7, wherein identifying the one or more clauses in the claim line includes applying a machine learning model to the claim line.

9. The system of claim 8, wherein the machine learning model is based on one or more of a supervised learning algorithm, an unsupervised learning algorithm, a semi-supervised learning algorithm, a regression algorithm, an instance-based algorithm, a regularized algorithm, a decision tree algorithm, a Bayesian algorithm, a clustering algorithm, an association rule learning algorithm, an artificial neural network algorithm, a deep learning algorithm, a dimensionality reduction algorithm, or an ensemble algorithm.

10. The system of claim 7, wherein identifying the one or more clauses in the claim line includes determining whether the claim line includes one or more markers, a given marker being a trigger word, a trigger phrase, or a trigger punctuation.

11. A method for providing a data structure representing patent claims, the method comprising:
obtaining a claim set, the claim set including a numbered list of sentences that precisely define an invention, the claim set including an independent claim and one or more dependent claims, each dependent claim in the claim set depending on the independent claim by referring to the independent claim or an intervening dependent claim;
processing a claim line of the claim set, the claim line being a unit of text having an end indicated by a presence of one or more end-of-claim line characters;
identifying one or more features in the claim line to be stored in the data structure, the one or more features including one or both of a main feature or a sub feature; and
storing the one or more features in the data structure;
wherein the main feature includes a step of a claimed process, a physical part of a claimed machine or article of manufacture, or a component of a claimed composition of matter; and
wherein the sub feature describes or expands on an aspect of a main feature.

12. The method of claim 11, wherein the data structure includes a specialized format for organizing and storing data, the data structure including one or more of an array, a list, two or more linked lists, a stack, a queue, a graph, a table, or a tree.

13. The method of claim 11, wherein the data structure includes language units from the claim set.

14. The method of claim 13, wherein the language units are organized in the data structure according to one or more classifications of individual language elements.

15. The method of claim 14, wherein a language element includes one or more of a word, a phrase, a clause, or a sentence.

16. The method of claim 14. wherein the one or more classifications include one or more of independent claim, dependent claim, preamble, main feature, sub feature, claim line, clause, phrase, or word.

17. The method of claim 11, further comprising identifying one or more clauses in the claim line.

18. The method of claim 17, wherein identifying the one or more clauses in the claim line includes applying a machine learning model to the claim line.

19. The method of claim 18, wherein the machine learning model is based on one or more of a supervised learning algorithm, an unsupervised learning algorithm, a semi-supervised learning algorithm, a regression algorithm, an instance-based algorithm, a regularized algorithm, a decision tree algorithm, a Bayesian algorithm, a clustering algorithm, an association rule learning algorithm, an artificial neural network algorithm, a deep learning algorithm, a dimensionality reduction algorithm, or an ensemble algorithm.

20. The method of claim 17, wherein identifying the one or more clauses in the claim line includes determining whether the claim line includes one or more markers, a given marker being a trigger word, a trigger phrase, or a trigger punctuation.
